(19) United States
(12) Patent Application Publication
(10) Pub. No.: US 2010/0331185 A1
(43) Pub. Date: Dec. 30, 2010

(54) Herbicidal Compositions of Lithium Glyphosate and Adjuvants

(75) Inventors: Benoit Abribat, Saint Fargeau Ponthierry (FR); Jianhua Mao, West Chester, OH (US); Rainer Hoefer, Duesseldorf (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/745,302

(22) PCT Filed: Nov. 21, 2008
(86) PCT No.: PCT/EP08/09853

§ 371 Date: May 28, 2010

Related U.S. Application Data
(60) Provisional application No. 60/991,270, filed on Nov. 30, 2007.

(51) Int. Cl. A01N 57/20; A01P 13/00

(52) U.S. Cl. 504/206

(57) ABSTRACT

Disclosed are herbicidal compositions comprising a lithium salt of glyphosate and one or more surfactants, the surfactant(s) enhancing the herbicidal efficacy of the lithium salt of glyphosate over that of the lithium salt of glyphosate alone.

### FIELD OF THE INVENTION

The present invention is related to the area of agro chemicals and refers to new herbicidal compositions and a method for fighting undesired vegetation by applying said compositions.

### BACKGROUND OF THE INVENTION

Glyphosate is well known in the art as an effective post-emergent foliar-applied herbicide. In its acid form, glyphosate is relatively insoluble in water (0.16% by weight at 25° C.). For this reason, it is typically formulated as a water-soluble salt.

Monobasic, dibasic and tribasic salts of glyphosate can be made. However, it is generally been preferred to formulate glyphosate and apply glyphosate to plants in the form of a monobasic salt. The most widely used salt of glyphosate is the mono (isopropylammonium), often abbreviated to IPA, salt. Commercial herbicides of Monsanto Company having the IPA salt of glyphosate as active ingredient include ROUNDUP®, ROUNDUP®ULTRA, ROUNDUP®XTRA, and RODEO® herbicides. All of these are aqueous solution concentrate (SL) formulations and are generally diluted in water by the user prior to application to plant foliage. Another glyphosate salt, which has been commercially formulated as SL formulations, includes the trimethylsulfonium, often abbreviated to TMS, salt, used for example in TOUCHDOWN® herbicide of Syngenta.

A potassium salt of glyphosate and surfactants suitable for use therewith are described in U.S. Pat. No. 7,049,270, which is incorporated herein by reference in its entirety. A major advantage of the IPA salt over many other salts of glyphosate has been the good compatibility in aqueous solution concentrate formulations of that salt with a wide range of surfactants. As used herein, the term “surfactant” is intended to include a wide range of adjuvants that can be added to herbicidal glyphosate compositions to enhance the herbicidal efficacy thereof, as compared to the activity of the glyphosate salt in the absence of such adjuvant, irrespective of whether such adjuvant meets a more traditional definition of “surfactant.”

Glyphosate salts generally require the presence of a suitable surfactant for best herbicidal performance. The surfactant can be provided in the concentrate formulation, or it can be added by the end user to the diluted spray composition.

It would be desirable to provide a storage-stable liquid or solid form concentrate composition (i.e. formulation) of the lithium salt of glyphosate, other than IPA and potassium glyphosate, having an agriculturally useful surfactant content, or that is “fully loaded” with surfactant. These formulations would exhibit a reduced viscosity, such that they may be pumped with standard bulk pumping equipment at 0° C. at rates of at least 7.5 gallons per minute, usually more than 10 gallons per minute, and preferably greater than 12.5 gallons per minute.

By “storage-stable”, in the context of an aqueous concentrate composition of glyphosate salt further containing a surfactant, is meant not exhibiting phase separation on exposure to temperatures up to about 50° C. for 14-28 days, and preferably not forming crystals of glyphosate or salt thereof on exposure to a temperature of about 0° C. For a period of up to about 7 days (i.e., the composition must have a crystallization point of 0° C. or lower). For aqueous solution concentrates, high temperature storage stability is often indicated by a cloud point of about 50° C. or higher. Cloud point of a composition is normally determined by heating the composition until the solution becomes cloudy and then allowing the composition to cool, with agitation, while its temperature is continuously monitored. A temperature reading taken when the solution clears is a measure of cloud point. A cloud point of 50° C. or higher is generally considered acceptable for most commercial purposes for a glyphosate SL formulation. Ideally the cloud point is 60° C. or higher, and the composition should withstand temperatures as low as about 10° C. for up to about 7 days without crystal growth, even in the presence of seed crystals of the glyphosate salt.

A surfactant that is described herein as “compatible” with a lithium glyphosate salt at the desired surfactant and glyphosate concentrations is one that provides a storage-stable aqueous concentrate, as defined immediately above, containing that surfactant and lithium glyphosate at the desired concentrations.

An “agriculturally useful surfactant content” means containing one or more surfactants of such a type or types and in such an amount that a benefit is obtained by the user of the composition in terms of herbicidal efficacy by comparison with an otherwise similar composition containing no surfactant. By “fully loaded” is meant having a sufficient concentration of a suitable surfactant to provide, upon conventional dilution in water and application to foliage, herbicidal effectiveness on one or more important weed species, without the need for further surfactant to be added to the diluted composition.

### DETAILED DESCRIPTION OF THE INVENTION

The present invention refers to Suggested are herbicidal compositions comprising a lithium salt of glyphosate and one or more surfactants, the surfactant(s) enhancing the herbicidal efficacy of the lithium salt of glyphosate over that of the lithium salt of glyphosate alone.

Surprisingly it has been observed that the herbicidal compositions of the invention can provide high rain-fastness, fast penetration into the cells of the target, and highly effective herbicidal properties.

Another aspect then of the present invention is a method of killing or controlling the growth of a plant which comprises applying the herbicidal composition of the invention to the plant in a quantity or amount sufficient to kill or control the growth of the plant.

By way of the present invention, the herbicidal composition can be applied in liquid or solid form. When used in liquid form, the composition can be provided either in aqueous solution, in organic solvents, as an emulsion, or as a suspension. Liquid and solid forms of lithium glyphosate can be prepared and provided for use.

### Herbicidal Compositions Comprising Lithium Glyphosate

The herbicidal compositions of the invention include herbicidal compositions of lithium glyphosate, and an herbicidal efficacy-enhancing amount of one or more surfactants. The compositions of the invention can also be provided in liquid or solid form. The compositions of the present invention are storage stable over a wide range of temperatures. As used herein throughout, the term “glyphosate” shall be understood to mean lithium glyphosate or the lithium salt of glyphosate acid or an ester thereof, unless specified otherwise. The herbicidal formulations of the present invention may optionally contain one or more additional surfactants, one or more additional herbicides, and/or other adjuvants or ingredients such as, for example, a dicarboxylic acid such as oxalic acid, or a salt or ester thereof. Formulations of the present invention may be prepared on site by the ultimate consumer shortly before application to the foliage of vegetation or weeds to be eliminated or controlled by diluting the liquid concentrate herbicidal formulations, or by dissolving or dispersing solid particles containing lithium glyphosate. Alternatively, herbicidal formulations of the present invention may be supplied to the ultimate consumer on a “ready-to-use” basis. Lithium glyphosate can be prepared by reacting glyphosate acid with lithium alkaline, such as lithium hydroxide or lithium carbonate, as illustrated below:

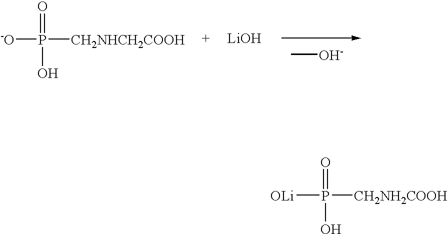

### Surfactants

Examples of suitable surfactants for use in the compositions of the invention are, but not limited to:
Alkyl polyglucosides (APG). An example of APG is: AGNIQUE® 8107, C810 APG, produced by Cognis Corp.
Aliphatic sulfate salts and aliphatic ether sulfate salts. Examples of aliphatic sulfate salts, but not limited to, are: sodium lauryl sulfate, TEXAPON® K 12 (Cognis); and examples of aliphatic ether sulfate salts are: sodium lauryl ether sulfate, POE (3), TEXAPON® NSO (Cognis) or higher ethoxylated lauryl ether sulfates like DISPONIL® FES 77 (Cognis). The salts here can be metal salts such as Na, K, Ca, Mg, or quaternary amine salts, such as tetramethyl ammonium. The aliphatic group may be saturated or unsaturated and/or straight chain or branched.
Aliphatic or aromatic sulfonates. Examples of sulfonates include: alkyl benzene sulfonates, such as sodium dodecylbenzene sulfonate; alkyl naphthalene sulfonates; and naphthalene sulfonate condensates, such as sodium salt of naphthalene sulfonate condensate.
Sulfosuccinates. Examples of sulfosuccinates are: dioctyl sulfosuccinate (DISPONIL® SUS IC 875, Cognis) and diisotridecyl sulfosuccinate.
Alcohols and alcohol alkoxylates. Examples of alcohols and alcohol alkoxylates include: LOROL® C8-10 alcohol and POE (10) oleyl alcohol. The hydrophobic part of alcohol can be either aliphatic or aromatic, can be either saturated or unsaturated, can be straight chain or branched. The alkoxide can be ethylene oxide, propylene oxide and/or butylene oxide. The alkoxylates can be random or block co-polymers.
Alkyl phenol alkoxylates, such as ethoxylated nonylphenol, POE (9).
Fatty acids and fatty acid (poly) glycol esters. Examples of fatty acids and fatty acid (poly) glycol esters include: coconut fatty acid, PEG 400 monooleate, and PEG 400 dioleate. It can be either mono or polyglycols. Typical glycols are ethylene glycol and propylene glycol; typical polyglycols are polyethylene glycol (PEG) and polypropylene glycol (PPG). It can also be a mixed polyglycol.
Mono or polyglycerol ethers or esters.
Polyol and alkoxylated polyol esters, such as: sorbitan monooleate (DISPONIL® SMO 100, Cognis), triethanolamine oleate, trimethylolpropane oleate, POE (20) sorbitan dioleate.
Alkoxylated triglycerides such as: ethoxylated soy bean oil, POE (30), ethoxylated caster oil, POE (25).
Amines, amine alkoxylates, and amides. Examples include: cocoamine ethoxylates, tallow amine ethoxylates, N,N-dihydroxylethyl tallow amide. Also included are multi- and/or polyamines and their derivatives, such as tetraethylenepentamine (TEPA) and polyethyleneimine.
Amine oxides and quaternary amines such as: cocoamine oxide and cetyl trimethyl ammonium chloride.
Phosphate esters such as: C₁₂₋₁₃ phosphate ester (either acid or salt form); and phosphate ester of POE (6) nonylphenol.
Amphoteric surfactants such as: sodium lauryl imino propionic acid.
A combination of the above-described surfactants, which combination enhances the herbicidal activity of lithium glyphosate.

Such surfactants are preferably used in lithium glyphosate concentrates containing at least 550 grams a.e. (acid equivalent) per litre of lithium glyphosate, and more preferably at least 560, 570 or 580 grams a.e. per litre of lithium glyphosate. It is preferred that such lithium glyphosate concentrates contain from about 550 to about 600 grams a.e. per litre of lithium glyphosate.

Alternatively, the surfactants are preferably formulated in lithium glyphosate concentrates containing at least 320 grams a.e. per litre of lithium glyphosate that contain a surfactant having a light colour of less than 10, preferably less than 9, 8, 7, 6, or 5 as measured using a Gardner colorimeter. In one embodiment, such concentrates include at least about 330 to about 580 grams a.e. per litre of lithium glyphosate. It is preferred that such lithium glyphosate concentrates contain from about 400 to about 600 grams a.e. per litre of lithium glyphosate, more preferably from about 450 to about 600, about 500 to about 600, about 540 to about 600, or about 550 to about 600 grams a.e. per litre of lithium glyphosate.

Alternatively, the surfactants are preferably incorporated in lithium glyphosate concentrates containing from about 20 to about 150 grams per litre of total surfactant in the formulation, more preferably from about 20 to about 130 grams per litre. In another embodiment, the surfactants are incorporated in lithium glyphosate concentrates containing from about 20 to about 150 grams per litre of total surfactant in the formulation and at least about 320 grams a.e. per litre of lithium glyphosate, more preferably at least about 330 to about 580 grams a.e. per litre of lithium glyphosate. It is preferred that such lithium glyphosate concentrates contain from about 400 to about 600 grams a.e. per litre of lithium glyphosate, more preferably from about 450 to about 600, about 500 to about 600, about 540 to about 600, or about 550 to about 600 grams a.e. per litre of lithium glyphosate.

### Concentrates and Diluted Compositions

The herbicidal formulations of the present invention include at least one surfactant that, in combination with glyphosate and upon application of the formulation to a plant or an application mixture prepared by dilution of the formulation with water, forms anisotropic aggregates comprising the surfactant on the foliage (epicuticular wax) of the plant. In some formulations of the present invention, a surfactant, in combination with glyphosate and upon application of the formulation to a plant or an application mixture prepared by dilution of the formulation with water, forms liquid crystals comprising the surfactant on the foliage of the plant (epicuticular wax). In other formulations of the present invention, a surfactant, in combination with glyphosate and upon application of the formulation to a plant or an application mixture prepared by dilution of the formulation with water forms liquid crystals comprising the surfactant both on the foliage of the plant (epicuticular wax) and with the plant itself (intracuticular liquid crystals). In other formulations of the present invention, a herbicidal formulation comprising an aqueous mixture containing glyphosate and a surfactant contains liquid crystals comprising the surfactant.

The herbicidal formulations of the present invention including glyphosate and a surfactant that forms anisotropic aggregates on a waxy plant surface may be prepared as aqueous concentrated formulations comprising at least about 50 g glyphosate a.e./L, more preferably at least about 250 g glyphosate a.e./L, still more preferably at least about 300, 360, 380, 400, 440, 480, 500, 540, or 600 g glyphosate a.e./L. One example of a preferred liquid concentrate glyphosate formulation contains about 360 g of glyphosate a.e./L, or about the same level as currently used by Monsanto Corporation in its commercial formulation of ROUNDUP® herbicide. Another preferred liquid concentrate glyphosate formulation contains the glyphosate at about 300 to about 600, preferably at about 400 to about 600, or preferably about 480 to about 540 g glyphosate a.e./L.

On a weight basis, stable aqueous concentrate compositions of the present invention including a surfactant that forms anisotropic aggregates on the cuticle surface can be made with glyphosate at a concentration of at least about 35, 40, 41, 42, 43, 44, 45, 46, 47, 48, 49, or 50% a.e. A concentration of about 35 to about 50% a.e., about 40 to about 50% a.e., about 45 to about 50% a.e., or higher is preferred.

In another embodiment, concentrated formulations which form anisotropic aggregates on the waxy surface of plants may be dry formulations which may be in the form of powders, pellets, tablets or granules. These dry formulations are typically dispersed or dissolved into water prior to use. Preferably, there are no substantially water-insoluble constituents present at substantial levels in such formulations, such that the formulations are substantially water-soluble. Dry water-soluble or water-dispersible formulations of the present invention typically comprise from about 20% to about 80% (by weight) glyphosate a.e., preferably from about 50% to about 80% (by weight) glyphosate a.e., and most preferably from about 60% to about 75% (by weight) glyphosate a.e.

In dry formulations of the present invention, the glyphosate itself may provide the support for other formulation constituents, or there may be additional inert ingredients which provide such support. One example of an inert support ingredient that may be used in accordance with the present invention is ammonium sulphate. It will be recognized by one skilled in the art that as used herein, the term “dry” does not imply that dry formulations of the present invention are 100% free of water. Typically, dry formulations of the present invention comprise from about 0.5% to about 5% (by weight) water. It is preferred that the dry formulations of the present invention contain less than about 1% (by weight) water.

Dry, water-soluble or water-dispersible formulations in accordance with the present invention can be produced by any process known in the art, including spray drying, fluid-bed agglomeration, pan granulation, or extrusion. In dry formulations, glyphosate may be present as a salt, or as an acid. Formulations containing glyphosate acid may optionally contain an acid acceptor such as a lithium carbonate or bicarbonate, or the like, so that upon dissolution or dispersion in water by the user a water-soluble salt of glyphosate is produced. Typically, herbicidal compositions of the present invention that are ready to be applied directly to foliage can be made with a glyphosate concentration of from about 1 to about 40 grams acid equivalent per litre, preferably from about 2 to about 18 grams acid equivalent per litre, more preferably from about 4 to about 11 grams acid equivalent per litre. One skilled in the art will recognize that various factors influence the application rate of glyphosate required for a desired result. Any convenient and herbicidal activity enhancing amount of the surfactant which comprises anisotropic aggregates on the waxy surface of a plant may be used in the glyphosate formulations of the present invention. Preferably, the surfactant is present in the concentrated glyphosate formulations of the present invention in a concentration of from about 25 to about 250 g/L, more preferably from about 50 to about 200 g/L. Although higher concentrations of the surfactant can be incorporated into the glyphosate formulations of the present invention, for economical reasons, it is generally more suitable to use the concentration ranges set forth above. Herbicidal formulations of the present invention that are ready to be applied directly to foliage can be made with a surfactant concentration of from about 0.1 g/L to about 10 g/L, preferably from about 1 g/L to about 5 g/L. In some herbicidal formulations of the present invention, the nature of the surfactant and the composition of the herbicidal formulation is such that upon application of the formulation to a plant or an application mixture prepared by dilution of the formulation with water, liquid crystals comprising the surfactant are formed on the foliage of the plant (epicuticular liquid crystals). In other words, liquid crystals comprising the surfactant form to create or enlarge hydrophilic channels through the epicuticular wax of the plant cuticle. A desirable feature of the herbicidal formulations of the present invention is that the surfactant be able to form liquid crystals in the presence of glyphosate on a waxy, porous substrate such as a leaf cuticle to produce transcuticular hydrophilic channels epicuticularly through the waxy cuticle. A distinguishing characteristic of the surfactants which comprise the liquid crystals in the presence of glyphosate is the tendency of the surfactant molecules to align them along a common axis in an ordered manner. Typically, liquid crystals have a higher degree of order than isotropic solutions and are much more fluid than solid crystals. Fluidity of liquid crystals may be a factor in the improved translocation of glyphosate throughout the plant.

Many of the surfactants discussed herein which form liquid crystals on the cuticle surface in the presence of glyphosate to facilitate translocation of the glyphosate throughout the infrastructure of the plant do not form liquid crystals in the concentrated glyphosate solutions at concentrations typically found to be commercially viable. Typically, these surfactants form liquid crystals in the dried down glyphosate/surfactant deposit that forms from drops or spraying of the diluted formulation onto the plant cuticle surface. Generally, and without being bound to a particular theory, it appears that the formation of liquid crystals in the concentrated glyphosate solution itself is not necessarily important or related (although in some circumstances it may be helpful) to the formation of liquid crystals on and in the plant surface. Typically, it is desirable that liquid crystals comprise the surfactant form as a dry-down deposit on the leaf surface. However, in some formulations, liquid crystals may form in the concentrated glyphosate/surfactant solutions on and in the leaf, but not in the diluted spray mixture.

As previously mentioned, the formation of liquid crystals epicuticularly may result from the drying down of glyphosate and surfactant containing droplets applied to the plant. Several environmental factors including air temperature, humidity, and wind speed may affect how quickly liquid crystals form in and on the plant. In some situations, the liquid crystals may actually be formed by phase separation from the main droplet on the foliage. Although the surfactants listed herein form liquid crystals in the presence of glyphosate, it is believed that it is preferable for surfactant molecules to have a molecular weight of less than about 2500. When the molecular weight of the surfactant is in excess of 2500, liquid crystals may still form but not be quite as effective and efficient in the translocation of glyphosate as lower molecular weight surfactants.

The liquid crystals comprising a surfactant in the presence of glyphosate epicuticularly are typically lyotropic liquid crystals. The formation of liquid crystals is typically induced by the presence of a solvent, in this case water. The mesophases of the liquid crystals depend not only on the solvent present, but also on temperature. Lyotropic liquid crystals comprising a surfactant in the presence of glyphosate that form transcuticular hydrophilic channels have been observed in hexagonal formation, reversed hexagonal formation, and lamellar and multilamellar formations having at least about 20 to about 30 or more separate, distinct layers. It may be possible to also have lyotropic liquid crystals in a cubical form. Also, both smectic and nematic forms of liquid crystals comprised of a surfactant in the presence of glyphosate have been observed. In the herbicidal formulations of the present invention, liquid crystals form regardless of the presence or absence of a second surfactant.

### Additional Ingredients

Although the present invention is directed primarily at liquid concentrate formulations of the lithium salt of glyphosate, such liquid concentrate formulations can optionally further comprise one or more additional pesticides, such as for example, water-soluble herbicidal active ingredients, including without restriction water-soluble forms of acifluorfen, asulam, benazolin, bentazon, bialaphos, bispyribac, bromacil, bromoxynil, carfentrazone, chloramben, clopyralid, 2,4-D, 2,4-DB, dalapon, dicamba, dichlorprop, diclofop, difenzoquat, diquat, endothall, fenac, fenoxaprop, flamprop, fluazifop, fluoroglycofen, fluoroxypyr, fomesafen, fosamine, glufosinate, haloxyfop, imazameth, imazamethabenz, imazamox, imazapic, imazapyr, imazaquin, imazethapyr, ioxynil, MCPA, MCPB, mecoprop, methylarsonic acid, naptalam, nonanoic acid, paraquat, picloram, sulfamic acid, 2,3,6-TBA, TCA and triclopyr.

Another ingredient that can optionally be added to the glyphosate herbicidal formulations of the present invention to further improve the herbicidal effectiveness and related herbicidal properties is a dicarboxylic acid or salt of a dicarboxylic acid. Suitable dicarboxylic acids that may be added to the herbicidal formulations comprising glyphosate or a salt or ester thereof and a surfactant as described herein include, for example, oxalic acid, malonic acid, succinic acid, glutaric acid, maleic acid, adipic acid, and fumaric acid, and combinations or mixtures thereof, with oxalic acid being preferred. Also, in addition to, or in place of the dicarboxylic acid, salts of the aforementioned dicarboxylic acids may be incorporated into the herbicidal formulations of the present invention to improve herbicidal performance. Suitable salts include, for example, alkali metal salts, alkanolamine salts and lower alkylamine salts. Preferred salts include potassium oxalate, dipotassium oxalate, sodium oxalate, disodium oxalate, diammonium oxalate, diethanolamine oxalate, dimethylamine oxalate, alkanolamine salts of oxalic acid, and lower alkylamine salts of oxalic acid.

Formulations containing a dicarboxylic acid such as oxalic acid or a dicarboxylic acid salt such as potassium oxalate, typically contain a sufficient amount of dicarboxylic acid/dicarboxylic acid salt to enhance the resulting efficacy of the herbicidal formulation. Typically, the weight ratio of total surfactant to carboxylic acid/carboxylic acid salt may be from about 1:1 to about 50:1, more preferably 5:1 to 40:1 and most preferably from about 5:1 to about 20:1. This ratio of total surfactant to carboxylic acid/carboxylic acid salt significantly enhances the herbicidal performance of the resulting herbicidal formulation.

The dicarboxylic acid or salt thereof which can be added to herbicidal formulations of the present invention to improve efficacy are suitable for use with glyphosate, or salts or esters thereof.

### INDUSTRIAL APPLICATION

The present invention also includes a method for killing or controlling weeds or unwanted vegetation comprising the steps of diluting a liquid concentrate in a suitable amount of water to form a tank mix, and applying a herbicidally-effective amount of the tank mix to the foliage of the weeds or unwanted vegetation. Similarly included in the invention is the method of killing or controlling weeds or unwanted vegetation which comprises diluting a solid particulate concentrate in a suitable amount of water to form a tank mix and applying a herbicidally-effective amount of the tank mix to the foliage of the weeds or unwanted vegetation.

In an herbicidal method of using a composition of the invention, the composition is diluted in a suitable volume of water to provide an application solution, which is then applied to foliage of a plant or plants at an application rate sufficient to give a desired herbicidal effect. This application rate is usually expressed as amount of glyphosate per unit area treated, e.g., grams acid equivalent per hectare (g a.e./ha). What constitutes a “desired herbicidal effect” is, typically and illustratively, at least 85% control of a plant species as measured by growth reduction or mortality after a period of time during which the glyphosate exerts its full herbicidal or phytotoxic effects in treated plants. Depending on plant species and growing conditions, that period of time can be as short as a week, but normally a period of at least two weeks is needed for glyphosate to exert its full effect.

The selection of application rates that are herbicidally effective for a composition of the invention is within the skill of the ordinary agricultural scientist. Those of skill in the art will likewise recognize that individual plant conditions, weather and growing conditions, as well as the specific active ingredients and their weight ratio in the composition, will influence the degree of herbicidal effectiveness achieved in practicing this invention. With respect to the use of glyphosate compositions, much information is known about appropriate application rates. Over two decades of glyphosate use and published studies relating to such use have provided abundant information from which a weed control practitioner can select glyphosate application rates that are herbicidally effective on particular species at particular growth stages under particular environmental conditions.

Herbicidal compositions of glyphosate salts are used to control a very wide variety of plants worldwide, and it is believed the lithium salt will prove no different from other salts of glyphosate in this regard.

Particularly important annual dicotyledonous plant species for control of which a composition of the invention can be used are exemplified without limitation by velvetleaf (Abutilon theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), morningglory (Ipomoea spp.), kochia (Kochia scoparia), mallow (Malva spp.), wild buckwheat, smartweed, etc. (Polygonum spp.), purslane (Portulaca spp.), russian thistle (Salsola spp.), sida (Sida spp.), wild mustard (Sinapis arvensis) and cocklebur (Xanthium spp.).

Particularly important annual monocotyledonous plant species for control of which a composition of the invention can be used are exemplified without limitation by wild oat (Avena fatua), carpetgrass (Axonopus spp.), downy brome (Bromus tectorum), crabgrass (Digitara spp.), barnyardgrass (Echinochloa crusgalii), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays). Particularly important perennial dicotyledonous plant species for control of which a composition of the invention can be used are exemplified without limitation by mugwort (Artemisia spp.), milkweed (Asclepias spp.), canada thistle (Cirsium arvense), field bindweed (Convolvulus arvensis) and kudzu (Pueraia spp.). Particularly important perennial monocotyledonous plant species for control of which a composition of the invention can be used are exemplified without limitation by brachiaria (Brachiaria spp.), bermudagrass (Cynodon dactylon), yellow nutsedge (Cyperus esculentus), purple nutsedge (C. rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.). Other particularly important perennial plant species for control of which a composition of the invention can be used are ex-emplified without limitation by horsetail (Equisetum spp.), bracken (Pteridium aquilinum), blackberry (Rubus spp.) and gorse (Ulex europaeus).

### Application of the Compositions

If desired, the user can mix one or more adjuvants with a composition of the invention and the water of dilution when preparing the application composition. Such adjuvants can include additional surfactant and/or an inorganic salt such as ammonium sulfate with the aim of further enhancing herbicidal efficacy. However, under most conditions, a herbicidal method of use of the present invention gives acceptable efficacy in the absence of such adjuvants. In a particular contemplated method of use of a composition of the invention, the composition, following dilution in water, is applied to foliage of crop plants genetically transformed or selected to tolerate glyphosate, and simultaneously to foliage of weeds or undesired plants growing in close proximity to such crop plants. This method of use results in control of the weeds or undesired plants while leaving the crop plants substantially unharmed. Crop plants genetically transformed or selected to tolerate glyphosate include those whose seeds are sold by Monsanto Company or under license from Monsanto Company bearing the ROUNDUP READY® trademark. These include, without restriction, varieties of cotton, soybean, canola, sugar beet, wheat and corn.

Plant treatment compositions can be prepared simply by diluting a concentrate composition of the invention in water. Application of plant treatment compositions to foliage is preferably accomplished by spraying, using any conventional means for spraying liquids, such as spray nozzles, atomizers or the like. Compositions of the invention can be used in precision farming techniques, in which an apparatus is employed to vary the amount of pesticide applied to different parts of a field, depending on variables such as the particular plant species present, soil composition, etc. In one embodiment of such techniques, a global positioning system operated with the spraying apparatus can be used to apply the desired amount of the composition to different parts of a field.

A plant treatment composition is preferably dilute enough to be readily sprayed using standard agricultural spray equipment. Useful spray volumes for the present invention can range from about 10 to about 1000 litres per hectare (l/ha) or higher, by spray application.

The following examples are illustrative of the invention and should not be construed as limiting the scope thereof.

### EXAMPLES

### Example 1

### Example of Preparation

35.2 g of glyphosate tech (96%, 0.208 mol) was mixed with 20 g water in a flask. 8.4 g of LiOH monohydrate was added to this mixture with good mixing. The resulting product was a hard paste. Up to 70 g additional water was added to the product, and the product dissolved when heated to about 55° C. When the solution was cooled to room temperature, the solid Li glyphosate precipitated out. The product pH (1%) was 4.98. Solubility of Li glyphosate in water and some common agrochemical organic solvents were measured and are listed in Table 1 below:

TABLE 1
Solubility

| Solvent | Li glyphosate Solubility, g/L |
|---|---|
| Water | <200 g/L |
| Agnique ME 610 | <50 g/L |
| Exxsol D-110 | <50 g/L |
| N-Methyl pyrrolidone | <150 g/L |
| Agnique KE 3658 | <100 g/L |

What is claimed is:

1. An herbicidal composition which comprises a lithium salt of glyphosate and one or more surfactants, said surfactant(s) enhancing the herbicidal efficacy of the lithium salt of glyphosate over that of the lithium salt of glyphosate alone.

2. The composition of claim 1, wherein said surfactant comprises an alkyl polyglucoside.

3. The composition of claim 1, wherein said surfactant has a light colour of less than 10, as measured by the Gardner color index.

4. The composition of claim 2, wherein said alkyl polyglucoside has a light color of less than 10, as measured by the Gardner color index.

5. The composition of claim 1, wherein said composition is in liquid or solid form.

6. The composition of claim 1, wherein said composition is a concentrate.

7. The composition of claim 1, wherein said composition is diluted with a solvent.

8. A method of killing, or controlling the growth of, undesired vegetation, which method comprises applying an herbicidal composition, which composition comprises a lithium salt of glyphosate and one or more surfactants, wherein said surfactant(s) enhances the herbicidal efficacy of the lithium salt of glyphosate over that of the lithium salt of glyphosate alone, on the undesired vegetation.
